(19) United States
(12) Patent Application Publication
(10) Pub. No.: US 2003/0016139 A1
(43) Pub. Date: Jan. 23, 2003

(54) Teach mode for remote control system

(76) Inventor: Rudor M. Teich, West Orange, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/054,306

(22) Filed: Jan. 22, 2002

Related U.S. Application Data
(60) Provisional application No. 60/305,772, filed on Jul. 17, 2001.

(51) Int. Cl. H04Q 1/00; G05B 19/00

(52) U.S. Cl. 340/825.22; 340/825.69; 340/5.71

(57) ABSTRACT

A system to prevent the accidental learning by a garage door opener (GDO) when it is the learn mode of the identification of a nearby “wrong” transmitter that happens to be operated. The receiver differentiates between two code types of a transmitter—an operate code and a teach code. An ID will be added to the GDO's authorization list only if the GDO is in the learn mode, and if it receives a teach code from an operated transmitter.

This application claims the benefit of U.S. provisional application No. 60/305,772, filed Jul. 17, 2001.

### BACKGROUND OF THE INVENTION

This invention relates to remote-controlled moveable barriers. Examples of such systems are gate openers and garage door openers. Throughout this application, the term Garage Door Opener (GDO) will be used to include any such mechanized barrier-control system. However, the invention may be applied to any application where there is a need to uniquely identify and link two or more devices that are in communication with each other. Examples of such non-GDO systems are wireless alarms systems, home light controls and, in general, addressable networks. The description that follows is by way of a GDO example, but the invention is more generally applicable.

Garage Door Openers have gained popularity and market acceptance due to the convenience, security and safety that they offer. The convenience is gained by the ability to open the garage door at the press of a push-button, rather than having to open a heavy door, or gate, manually. The security element can be attributed to the ability of an authorized person to gain access to the garage from the safety of a locked car. The safety element is linked to the ability of the system to control a heavy door or gate while reversing movement in the case of entrapment of a person or a solid object. In one such system, disclosed in U.S. Pat. No. 5,493,812, a wireless infrared beam causes the GDO to reverse if the beam is interrupted while the barrier is closing.

A remote-controlled GDO comprises a motor-controller and at least one remote transmitter. The transmitter is used to open or close the barrier from a distance, e.g., from a user's car. The transmitter thus acts as an electronic key to unlock and open the barrier. Transmitters are also used to provide operational information to the GDO.

The security requirements of a GDO system dictate that the GDO respond only to commands from an authorized source. This is achieved by maintaining a list of the authorized transmitters' identification (ID) codes in the GDO's controller.

In operation, the transmitter sends out a code that includes the transmitter's ID, as well as a command for the GDO controller, e.g., open the barrier. The controller receives the signal and decodes it. It also compares the ID of the transmission with the IDs that have been authorized. If it finds a match, it will respond to honor the command that it received.

There are two fundamental methods for storing an ID in a transmitter. One method involves setting jumpers or switches on the transmitter. An example of a system which utilizes switches to set the code in the transmitter is described in U.S. Pat. No. 3,906,348 to Willmott.

The second method stores the ID number in a non-volatile semiconductor memory in the transmitter. An example of a system where the ID of the transmitter is stored in a semiconductor memory is described in U.S. Pat. No. 4,750,118 to Heitschel et al.

In addition to storing an ID in the transmitter, there is a similar requirement to store authorized ID codes in the controller. Here, too, the code can be stored by switches (U.S. Pat. No. 3,906,348), or in semiconductor memory (U.S. Pat. No. 4,750,118). The two types of ID storage can be mixed—for example, storing the ID code in the transmitter using switches, and storing the authorized code(s) in the controller in a semiconductor non-volatile memory.

The current state of the art of garage door openers has evolved to accommodate a number of transmitters, where each can control the same barrier. For example, a family with two cars and a two-car garage can be provided with two transmitters so that each car can be equipped with its own transmitter. This allows the two drivers to open the garage door from the comfort and safety of their individual cars. Such a system is described in U.S. Pat. No. 4,750,118. It is commercially available from The Chamberlain Group of Elmhurst, Ill., and others.

In controllers that support a multitude of transmitters, the most common method of storing the transmitter ID list is by the use of semiconductor memory. In the current generation of GDO products, each transmitter is assigned a unique ID code, which is programmed into it at the factory. Although only a finite number of code combinations is available, the number of these combinations runs into the millions and it is thus statistically unlikely that two transmitters will have the same address. There is no provision for changing the ID-code of a transmitter in the field.

The industry has adopted an encryption concept where the transmitter sends an apparent ID code that changes with each transmission. This copy-resistant code technique is referred to as “rolling,” “roaming” or “hopping” code. With rolling codes, only the appearance of the address changes with each activation. The underlying ID is traceable through encryption techniques to the factory-set address. For the purpose of this description, the transmitter address code can be said to be fixed. An example of such a rolling code system is described in U.S. Pat. No. 6,049,289 to Waggamon et al.

The process by which a transmitter's ID is added to the authorization list in the GDO is called learning. The most common learning process involves three steps:

(1) The GDO controller is placed in a learning mode using a switch on the controller.

(2) The transmitter is activated in operating proximity to the GDO. The transmitter sends a normal operating command packet, identical to the command used to operate the barrier.

(3) The ID of the transmitter is added to the list, and, if necessary, the ID of an older-entry is deleted from the list to make room for the new addition This process links the addition of a new code in the GDO with the deletion of an older code. The need to delete an ID when a new one is added is imposed by the reality of having a limited space in which to store transmitter IDs. The need to restrict the number of transmitter codes in the list is also mandated by the time it takes to search the list for a match; the longer the list, the longer the delay between the transmission and the resultant barrier activation.

In memory systems using semiconductor storage, the IDs of the individual transmitters in the list are not usually accessible for modification. This limitation is mandated by the cost of adding a display to allow access to an individual ID in the list and to identify its owner. An early method proposed in U.S. Pat. No. 4,750,118, where a selector switch assigns specific memory locations for the storage and retrieval of IDs in the list, did not gain favor in the industry, as it required keeping records of which transmitter ID was stored in each location. Subsequently, a sequential memory approach was adopted.

To teach a GDO a new code, the GDO is usually placed in a learn mode by operating an appropriate switch or button on the GDO. Then the transmitter whose code is to be learned is operated. When the code is received while the GDO is in the learn mode, the code is added to the GDO's list, displacing the earliest stored code in a FIFO memory if necessary. (The reason that a button on the GDO must be operated to place the GDO in the learn mode is that learning of new codes has to be authorized, and it is assumed that anyone who has access to the GDO is authorized to control storage of new codes.)

The problem with this standard prior art approach is that there is a real possibility of learning a wrong code. When the GDO is placed in the learn mode, it will add to its authorized list the first transmitter ID that it decodes while in this mode. If, while the GDO is in the learn mode, a transmitter nearby is operated (e.g., to open a neighbor's door), that code will be entered into the GDO. Once the code is stored in the GDO, the GDO memory will need to be flushed and all previously taught transmitter IDs will have to be re-learned.

It is an object of this invention to prevent the accidental learning of the identification code of a “wrong” transmitter operated nearby when learning the ID of a new transmitter.

### SUMMARY OF THE INVENTION

To prevent the accidental learning by the GDO of the ID of a “wrong” transmitter that may be operated nearby, the receiver differentiates between two code types of a transmitter—operate codes and teach codes. An ID will be added to the list only if the controller is in the learn mode, and if the transmitter is in the teach mode (in which a teach code is transmitted).

In operation, the GDO controller is placed in the learn state through any one of the methods known in the art. The transmitter is placed in a teach mode through a special switch or, in the preferred embodiment, by pressing a timed-sequence on a switch that is used to remotely operate the GDO from the transmitter. Upon entering this mode, the transmitter changes its ID to a new pseudo-random value. (As will be described below, changing the ID code of a transmitter when its code is to be added to the list of a new GDO eliminates the need to flush out all codes from the list of the old GDO with which the transmitter was previously used.) The transmitter then proceeds to send a coded packet that identifies its source, indicates that this is a teach packet and includes the new ID code. The packets can be repeated a few times, but once the teach mode is exited, the transmitter returns to its normal operate mode.

Unlike transmitters known in the art where the same transmission packet is used to operate the GDO and to program a new ID into it, the GDO of my invention will accept an addition to its authorization list only if the new ID is in a recognizable teach packet. It will ignore normal command or operate packets, even if the controller is in the learn mode. This prevents the learning of a “wrong” ID if a neighbor's transmitter is operated while the GDO is in the learn mode.

Although U.S. Pat. No. 6,049,289 teaches the use of a random memory assignment, where a new entry displaces a previous one selected at random, most systems on the market today use a First-In-First-Out (FIFO) list strategy, where the oldest entry in the list is the one that gets deleted when a new entry is added. The transmitters in use usually have fixed IDs, usually preset at the factory where an ID code can be set to a unique value, unduplicated by any other transmitter manufactured by the same company. As a consequence of this methodology, if there is a need to replace a transmitter in the list in the GDO controller, the entire list must be deleted and replaced. It is not possible to surgically identify and remove a specific transmitter from the list. This constitutes a significant inconvenience, especially in applications where a significant number of vehicles use a common barrier. Examples of such applications are a gate that controls access to a parking area and a truck depot where a number of trucks use a loading bay behind a remote-controlled door.

If a truck is to be reassigned to another bay, its transmitter needs to be removed from the list of the original bay and added to the new bay. In the existing art, this requires that the GDO controlling the first bay be purged of all codes (typically, by teaching the GDO enough new codes, which can all be the same and even fictitious, to fill up all locations in the FIFO memory), and the ID of each of the trucks that had the right to use that bay must be re-programmed (learned) again when the trucks arrive at the bay. This can be a serious inconvenience, especially if the trucks arrive after working hours.

In the illustrative embodiment of the invention, a transmitter ID can be effectively cancelled in the authorized list in the controller without having to make any entries in the controller, thus alleviating the shortcomings of the existing systems. A GDO is effectively made to ignore a previously authorized transmitter, without having to access the GDO, by changing the ID code of the transmitter as part of the procedure to teach the code to a new GDO controller. Rather than to flush all codes from the old GDO, the transmitter is operated only to add its ID to the list of another GDO. The transmitter, when placed in the “teach” mode for teaching a new GDO its code, has its code automatically changed. The new code is randomly generated and cannot be traced to the previous code. The GDO with which the transmitter previously worked still has the old code on its list, but now there is no transmitter that uses that code. Effectively, then, the old code has been removed from the list of codes used with this GDO. This procedure works even if a new GDO is in fact not having a new ID code added to its list. Simply operating the transmitter as though it is programming a new GDO causes its code to change, effectively disabling the transmitter from operating the GDO with which it previously worked. To effectively remove an ID code from a GDO's list, it is no longer necessary to flush all codes from the list.

It is desirable to be able to share one transmitter to control the GDOs at home and in the office, or in a second home. One limitation of the system described thus far is that it is not possible to program two GDOs to use a common transmitter because each time the transmitter is placed in the teach mode its ID is changed. Thus, when the second GDO is taught the ID of the transmitter, the first GDO will no longer recognize the code as it has changed since the code was taught to that GDO.

Another disadvantage of the system as described thus far is that the GDO must be placed in the learn mode just prior to the transmission of the teach command. If the GDO times out before the teach command is actually sent, the user must restart the entire procedure. This can be a problem when guiding the user by phone how to program the GDO, and the phone is not in the immediate vicinity of the transmitter. Because the transmitter is usually battery powered, the transmitter needs to automatically shut off after a preset time. In order to conserve battery life, the automatic shut off is usually well less than one minute. By the time the user has placed the transmitter in the teach mode and returned to the garage area, the transmitter has shut off. Starting it again requires going through the procedure to place the transmitter in the teach mode all over again.

These problems are solved by allowing the transmitter to transmit concurrently operate commands and teach commands for the next few activations of the transmitter following a teach state. The teach packets sent under this mode are identical to the ones sent during the preceding teach mode. This feature is referred to as “latent teach”. The latent teach allows the user to make another attempt to have the GDO learn the code of the transmitter, without having to first place the transmitter in the teach mode another time. The latent teach also allows programming two GDOs using a common transmitter. Because the teach packets sent in the latent teach state are unchanged from the packets used to program the first GDO, the second GDO can be taught the same ID code as the first one. This allows both GDOs to honor commands from a common transmitter.

### BRIEF DESCRIPTION OF THE DRAWINGS

Further objects, features and advantages of the invention will become apparent upon consideration of the following detailed description in conjunction with the drawing, in which:

FIG. 1 is a block diagram of a remote-control barrier control system with a remote transmitter and a motor controller with an integrated RF receiver;

FIG. 2 is a flow chart of the processing in the transmitter when its operate button is depressed;

FIG. 3 is a flow chart of the processing in the transmitter if the button activation is decoded to be a command to operate the barrier;

FIG. 4 a flow chart of the processing in the transmitter if the button activation is decoded to be a command to teach the controller a new transmitter ID;

FIG. 5 is a flow chart of the processing in the controller of a new RF packet; and

FIG. 6 is a flow chart of the processing in the controller of a learn packet.

### DETAILED DESCRIPTION

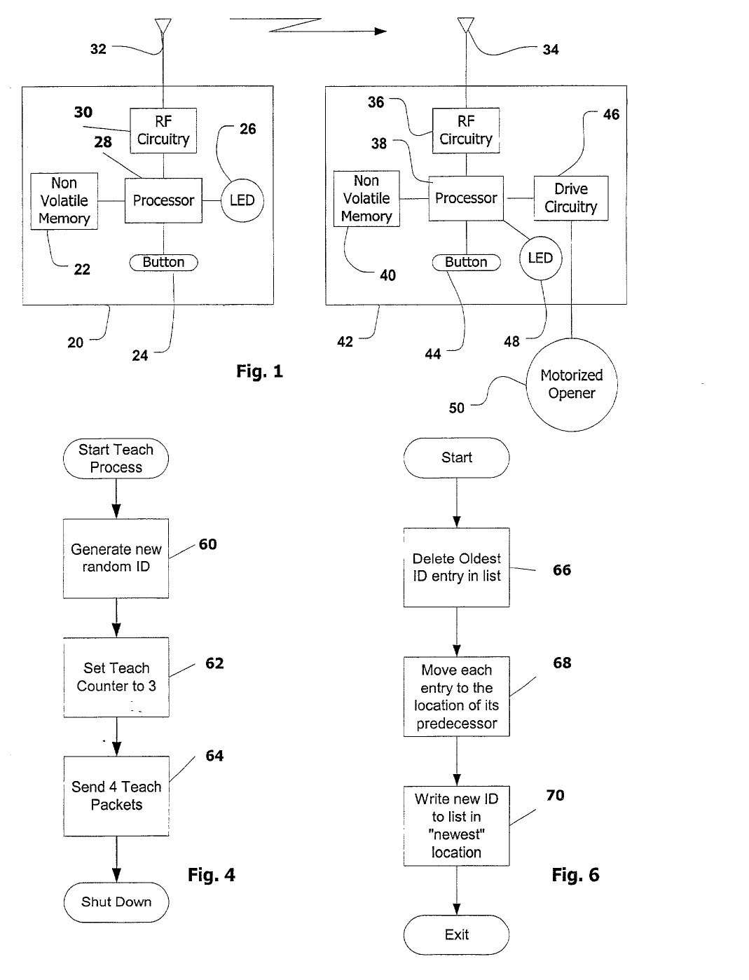

FIG. 1 shows the main elements in a remote-control system for moveable barriers. A controller 42 is provided with drive circuitry 46 that can directly power a barrier opener such as a motorized garage door opener 50. The drive circuitry 46 is in turn controlled by a processor 38. The processor is a microprocessor in FIG. 1, but it can be a custom integrated circuit. The processor receives suitable RF signals from receiver 36 which receives them via antenna 34.

The controller 42 can be in one of two states—the operate state and the learn state. The operate state is the normal state in which the controller is responsive to suitable and authorized commands from transmitters such as transmitter 20 shown in FIG. 1. Such commands are in turn sent to the drive circuitry 46 to control the barrier to open, close or stop moving.

In the learn state, the controller ignores any operate command, but will honor special teach commands. When a suitable teach command is received when the controller is in the learn state, the ID of the transmitter is added to the authorization list that is stored in the non-volatile memory 40.

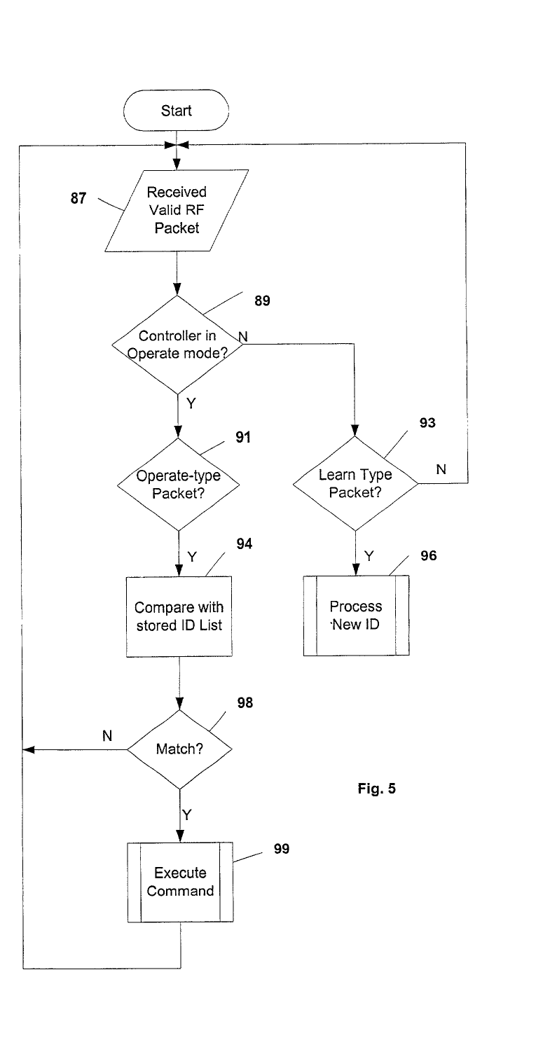

FIG. 5 shows a simplified flow chart for the processing of RF signals in the controller. The controller will process only signals that meet certain structural criteria known as packets. This technique is known in the art and will not be further described here. It is illustrated in step 87. When a valid packet arrives, it will be processed if the type of the packet matches the state of the controller (steps 89, 91 and 93). An operate packet will be processed only if the controller is in the operate state, and a learn packet will only be processed (step 96) if the controller is in the learn state.

When an operate packet is accepted, the ID of the initiating transmitter, which is embedded in the packet, is compared in step 94 with the authorized ID list which is stored in the memory 40. Only in the case of a match (step 98) will the command be executed (step 99).

FIG. 6 is a simplified flow chart for the processing of learn packets that are received when the controller is in the learn state. In the illustrative controller, the ID list is organized as a first-in-first-out (FIFO) shift register. When a new entry needs to be added, the oldest ID is deleted from the list (step 66), and all the rest of the IDs are moved, each to the position previously held by the next oldest entry (step 68). This frees up the position for the newest entry, where the new ID is now stored (step 70).

Similarly to the controller, each transmitter used in the illustrative system must also be operable in one of two states—an operate state and a teach state. These states correspond to the operate and learn states of the controller, respectively.

Returning to FIG. 1, the transmitter 20 comprises a processor 28, an RF transmitter 30 and associated antenna 32. The processor can be a microprocessor or a custom integrated circuit. Non-volatile memory 22 holds the unique ID of the transmitter. The transmitter, which is battery operated, is usually off. Pressing button 24 wakes up the processor 28. In the normal operating mode, the processor proceeds with sending an RF packet that is associated with the desired function of the button 24.

In the illustrative transmitter, one button is used to achieve all the required functions of operating and teaching the GDO controller. However, nothing in this description should be construed as limiting the invention to such a single-button transmission. The invention encompasses transmitters with a multitude of buttons as well. For example, there are transmitters where separate buttons are provided for sending an “open” command, a “stop” command and a “close” command to the controller. There are also transmitters which have a separate internal switch to place the transmitter in the teach and in the operate modes. In the preferred embodiment of the transmitter, a single button is used to implement all the above commands. (As is known in the art, a command may mean different things depending on the state of the door being operated—a single command may mean “open” if the door is closed, “close” if the door is open, and “stop” if the door is in motion.)

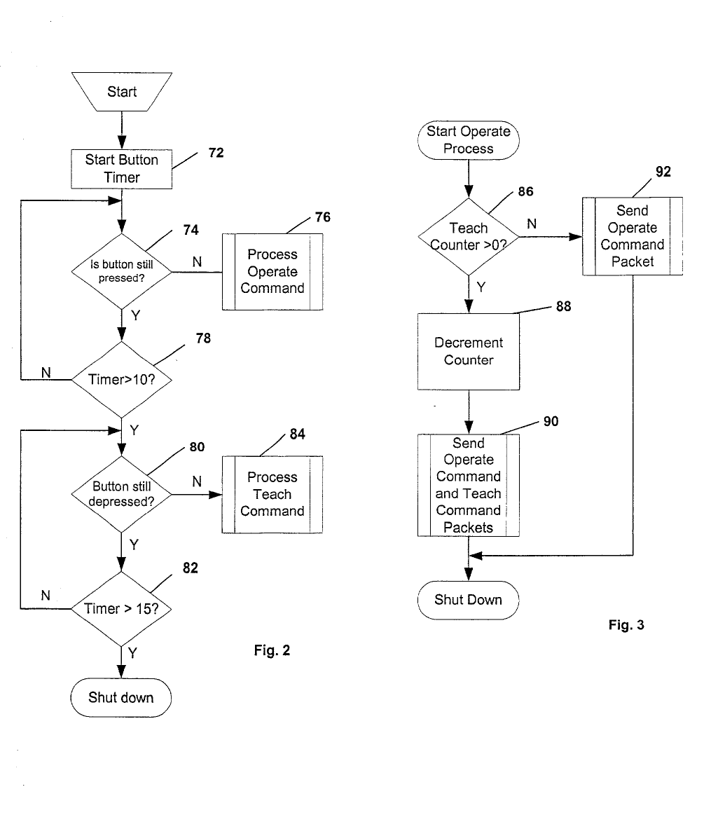

FIG. 2 is a simplified flow chart of the processing when the button 24 on the transmitter is depressed. The same button is used to send an operate command, as well as to place the transmitter in the teach mode. This is achieved by timing the duration of the button closure. In the illustrative system, holding the button and releasing it after less than 10 seconds (steps 72 and 74) will send an operate packet (step 76). Holding the button for more than 10 seconds and less than 15 seconds (steps 78 and 80) will place the transmitter in the teach mode (step 84). Holding the button for longer than 15 seconds (step 82) will return the transmitter back to the sleep mode, to conserve battery in case the button is accidentally held in the push position.

To guide the user in the timing of the button when it is desired to enter the teach mode, once the button has been held for 10 seconds, LED 26 on the transmitter starts to flash. This is the indication to the user that the button needs to be immediately released in order to place the transmitter in the teach mode.

FIG. 4 is a simplified flow chart of the operation of the transmitter once it has entered the teach state. The processor first generates a pseudo-random ID code in a manner that is known in the art (step 60). The new ID is stored in the non-volatile memory 22 (FIG. 1). The processor then proceeds to set up a teach counter (step 62) to a preset value. The function of the teach counter is to allow latent teach for a preset number of times that the transmitter is activated in operate mode after it was placed in the teach mode. In the example, the counter is set to a value of 3. As will be shown, this will result in latent teach during the first 3 activations after the teach mode.

The processor in the transmitter then proceeds to send RF teach packets (step 64). To increase the likelihood of successfully learning the code at the controller, the packet is sent a few times in a row. In the example, it is sent 4 times. The transmitter then shuts down.

FIG. 3 is a simplified flow chart of the sequence of operation of the transmitter if the button was pressed for a relatively short period of time, enabling an operate transmission. The teach counter 51 is first examined (step 86). If it is nonzero, it is decremented (step 88) and the processor then sends sequentially both an operate packet and a teach packet (step 90). If the counter is zero, the processor will send only an operate packet (step 92). Once the packets, which may be repeated for redundancy, are sent, the transmitter shuts down.

Although the invention has been described with reference to a particular embodiment, it is to be understood that this embodiment is merely illustrative of the application of the principles of the invention. Numerous modifications may be made therein and other arrangements may be devised without departing from the spirit and scope of the invention.

What I claim is:

1. A remote control system having a receiver and one or more transmitters, each transmitter transmitting a respective identification code along with a command and the receiver having a list of identification codes associated with authorized transmitters, the receiver being operable in a learn mode during which it may receive a transmitted identification code for addition to its list, the improvement in which a transmitter can be placed in an operate mode and a teach mode, the transmitter transmitting its identification code in both modes but the forms of transmission being different in the two modes, and the receiver operates to add a received authorization code to its list only if the form of the received transmission is that of a transmitter teach mode.

2. A remote control system in accordance with claim 1 wherein the identification code of a transmitter is automatically changed when the transmitter is to have its identification code added to the receiver list.

3. A remote control system in accordance with claim 2 wherein a new identification code is randomly generated and cannot be traced to the previous identification code.

4. A remote control system in accordance with claim 2 wherein after the identification code of a transmitter is automatically changed, the form of transmission is that of the teach mode for a number of succeeding transmissions but with the same changed identification code.

5. A remote control system in accordance with claim 1 wherein whenever the transmitter is first operated in the teach mode following operation in the operate mode, the transmitter operates a number of times in succession in the teach mode.

6. A remote control system in accordance with claim 5 wherein whenever the receiver is in the learn mode, received transmitter commands are ignored.

7. A remote control system in accordance with claim 1 wherein whenever the receiver is in the learn mode, received transmitter commands are ignored.

8. A remote control system in accordance with claim 1 wherein a transmitter has a manually operated button and the transmitter mode of operation is determined by the length of time that the button is operated.

9. A remote control system having a receiver and one or more transmitters, each transmitter transmitting a respective identification code along with a command and the receiver having a list of identification codes associated with authorized transmitters, the receiver being operable in a learn mode during which it may receive a transmitted identification code for addition to its list, the improvement comprising means for placing the transmitter in an operate mode and a teach mode, the transmitter transmitting its identification code in both modes but the forms of transmission being different in the two modes, and means in the receiver for controlling the addition of a received authorization code to the receiver list only if the form of the received transmission is that of a transmitter teach mode.

10. A remote control system in accordance with claim 9 wherein the identification code of a transmitter is automatically changed when the transmitter is to have its identification code added to the receiver list.

11. A remote control system in accordance with claim 10 wherein a new identification code is randomly generated and cannot be traced to the previous identification code.

12. A remote control system in accordance with claim 10 wherein after the identification code of a transmitter is automatically changed, the form of transmission is that of the teach mode for a number of succeeding transmissions but with the same changed identification code.

13. A remote control system in accordance with claim 9 wherein whenever the transmitter is first operated in the teach mode following operation in the operate mode, the transmitter operates a number of times in succession in the teach mode.

14. A remote control system in accordance with claim 13 wherein whenever the receiver is in the learn mode, received transmitter commands are ignored.

15. A remote control system in accordance with claim 9 wherein whenever the receiver is in the learn mode, received transmitter commands are ignored.

16. A remote control system in accordance with claim 9 wherein a transmitter has a manually operated button and the transmitter mode of operation is determined by the length of time that the button is operated.

17. A method for operating at least one remote control transmitter that is associated with a receiver, the transmitter transmitting a respective identification code along with an operate command and the receiver having a list of identification codes associated with authorized transmitters, the receiver being operable in a learn mode during which it may receive a transmitted identification code for addition to its list, the method comprising selectively placing the transmitter in an operate mode or a teach mode, controlling the transmitter to transmit its identification code in both modes but the forms of transmission being different in the two modes, and controlling the receiver to add a received authorization code to the receiver list only if the form of the received transmission is that of a transmitter teach mode.

18. A method in accordance with claim 17 further including the step of automatically changing the identification code of a transmitter when the transmitter is to have its identification code added to the receiver list.

19. A method in accordance with claim 18 wherein a new identification code is randomly generated and cannot be traced to the previous identification code.

20. A method in accordance with claim 18 wherein after the identification code of a transmitter is automatically changed, the form of transmission is that of the teach mode for a number of succeeding transmissions but with the same changed identification code.

21. A method in accordance with claim 17 wherein whenever the transmitter is first operated in the teach mode following operation in the operate mode, the transmitter operates a number of times in succession in the teach mode.

22. A method in accordance with claim 21 further including the step of having the receiver ignore received transmitter commands whenever the receiver is in the learn mode.

23. A method in accordance with claim 17 further including the step of having the receiver ignore received transmitter commands whenever the receiver is in the learn mode.

24. A method in accordance with claim 17 wherein a transmitter has a manually operated button and further including the step of determining the transmitter mode of operation in accordance with the length of time that the button is operated.

25. A transmitter for a remote control system, said remote control system having a receiver that stores a list of identification codes associated with one or more authorized transmitters, the receiver being operable in a learn mode during which it may receive a transmitted identification code for addition to its list, the transmitter operating to transmit an identification code along with an operate command, the improvement in which a transmitter can be placed in an operate mode and a teach mode, the transmitter transmitting its identification code in both modes but the forms of transmission being different in the two modes in order to enable the receiver to add a received authorization code to its list only if the form of the received transmission is that of a transmitter teach mode.

26. A transmitter in accordance with claim 25 further including means for automatically changing the identification code of the transmitter when the transmitter is to have its identification code added to the receiver list.

27. A transmitter in accordance with claim 26 wherein a new identification code is randomly generated and cannot be traced to the previous identification code.

28. A transmitter in accordance with claim 26 wherein after the identification code of a transmitter is automatically changed, the form of transmission is that of the teach mode for a number of succeeding transmissions but with the same changed identification code.

29. A transmitter in accordance with claim 25 wherein whenever the transmitter is first operated in the teach mode following operation in the operate mode, the transmitter operates a number of times in succession in the teach mode.

30. A remote control system in accordance with claim 25 wherein the transmitter has a manually operated button and means for determining the transmitter mode of operation in accordance with the length of time that the button is operated.

31. A transmitter for a remote control system, said remote control system having a receiver that stores a list of identification codes associated with authorized transmitters, the receiver being operable in a learn mode during which it may receive a transmitted identification code for addition to its list, comprising means for controlling the transmitter to transmit an identification code along with an operate command, and means for placing the transmitter in an operate mode and a teach mode, the transmitter transmitting its identification code in both modes but the forms of transmission being different in the two modes in order to enable the receiver to add a received authorization code to its list only if the form of the received transmission is that of a transmitter teach mode.

32. A transmitter in accordance with claim 31 further including means for automatically changing the identification code of the transmitter when the transmitter is to have its identification code added to the receiver list.

33. A transmitter in accordance with claim 32, wherein a new identification code is randomly generated and cannot be traced to the previous identification code.

34. A transmitter in accordance with claim 32 wherein after the identification code of a transmitter is automatically changed, the form of transmission is that of the teach mode for a number of succeeding transmissions but with the same changed identification code.

35. A transmitter in accordance with claim 31 wherein whenever the transmitter is first operated in the teach mode following operation in the operate mode, the transmitter operates a number of times in succession in the teach mode.

36. A transmitter in accordance with claim 31 wherein the transmitter has a manually operated button and means for determining the transmitter mode of operation in accordance with the length of time that the button is operated.
